(19) United States
(12) Patent Application Publication
(10) Pub. No.: US 2025/0142657 A1
(43) Pub. Date: May 1, 2025

(54) URSP EVALUATION FOR UNKNOWN PDU SESSION TYPE

(71) Applicant: Nokia Technologies Oy, Espoo (FI)

(72) Inventors: Mohamed Amin NASSAR, Munich (DE); Sung Hwan WON, Dallas, TX (US); Ioannis MOUROULIS, Athens (GR)

(21) Appl. No.: 18/924,690

(22) Filed: Oct. 23, 2024

(30) Foreign Application Priority Data
Oct. 31, 2023 (GB) 2316661.4

(51) Int. Cl. H04W 76/18

(52) U.S. Cl. CPC H04W 76/18

(57) ABSTRACT

A UE transmits a first message including a request to establish communication based on a first communication session type and a first set of one or more session attributes associated with the first message. The UE receives a second message including an indication that the request to establish communication using the first communication session type is rejected. After receiving the second message, the UE removes from use, a retransmission of the first communication session type and the first set of one or more session attributes for establishing communication, and transmits a third message including a request for communication based on a second communication session type and a second set of one or more session attributes, associated with the third message. A combination of the first communication session type and the first set, is not identical to a second combination including the second communication session type and the second set.

### FIELD

Various example embodiments relate generally to wireless networks and, more particularly, to user equipment route selection policy (URSP) evaluation for unknown packet data unit (PDU) session type.

### BACKGROUND

In order for a user equipment (UE) to exchange packet data units (PDUs) with a data network in a 5G system, the UE first initiates a PDU session establishment procedure. Such a procedure may be defined, for example in section 4.3.2.2 of the third generation partnership project (3GPP) TS 23.502. Once the UE initiates the PDU session establishment procedure that includes a route selection descriptor (RSD) for a PDU session type, the session is either accepted or rejected by the network (e.g., a session management function (SMF) in the network). In the case, where the PDU session is rejected, the UE will continue to attempt to initiate the PDU session with the RSD additional times, resulting in subsequent rejections of the PDU session.

### SUMMARY

In an aspect of the present disclosure, a method includes transmitting, by a user equipment (UE), a first message to a first apparatus, the first message including a request to establish communication based on a first communication session type and a first set of one or more session attributes associated with the first message. The UE receives a second message from the first apparatus, the second message including an indication that the request to establish communication using the first communication session type is rejected, and after the receiving the second message, removes from use, a retransmission of the first communication session type and the first set of one or more session attributes for establishing communication, and transmits a third message to the first apparatus or a second apparatus, the third message including a request for communication based on a second communication session type and a second set of one or more session attributes, associated with the third message, wherein a first combination including the first communication session type and the first set of one or more session attributes, is not identical to a second combination including the second communication session type and the second set of one or more session attributes.

In an aspect of the method, the request to establish communication based on the first communication session type includes a request to establish a protocol data unit (PDU) communication session type or a packet data network (PDN) communication session type.

In an aspect of the method, the PDU communication session type includes one or more of the following: an IPv4 communication session type, an IPv6 communication session type, an IPv4v6 communication session type, an Unstructured communication session type or an Ethernet communication session type.

In an aspect of the method, the PDN communication session type includes one or more of the following: an IPv4 communication session type, an IPv6 communication session type, an IPv4v6 communication session type, non-Internet protocol (IP) communication session type or an Ethernet communication session type.

In an aspect of the method, the first set of one or more session attributes comprises a first data network name (DNN) or a first access point name (APN).

In an aspect of the method, the second set of one or more session attributes comprises a second DNN or a second APN.

In an aspect of the method, the first set of one or more session attributes comprises a first single network slice selection assistance information (S-NSSAI).

In an aspect of the method, the second set of one or more session attributes comprises a second S-NSSAI.

In an aspect of the method, the first communication session type and the first set of one or more session attributes are included in a first route selection descriptor (RSD).

In an aspect of the method, the second communication session type and the second set of one or more session attributes are included in a second RSD.

In an aspect of the method, the first communication session type and the second communication session type are identical or the first set of one or more session attributes and the second set of one or more session attributes are identical.

In an aspect of the method, the second message is a 5G system session management (5GSM) message that includes an indication of an unknown PDU session type.

In an aspect of the method, the second message includes a 5GSM cause value #28 unknown PDU session type.

In an aspect of the method, the second message is an evolved packet system session management (ESM) message that includes an indication of an unknown packet data network (PDN) session.

In an aspect of the method, the second message is an ESM cause value #28 unknown PDN session message.

In an aspect of the method, the removing from use includes storing, by the UE, the first combination as a combination to not be used.

In an aspect of the method, prior to transmitting the third message, consulting, by the UE, the combinations to not be used.

In an aspect of the present disclosure, a user equipment (UE) includes at least one processor, and at least one memory storing instructions which, when executed by the at least one processor, cause the user equipment at least to perform any of the foregoing methods.

In an aspect of the present disclosure, an apparatus includes at least one processor, and at least one memory storing instructions which, when executed by the at least one processor, cause the apparatus at least to perform any of the foregoing methods.

In an aspect of the present disclosure, a processor-readable medium storing instructions which, when executed by at least one processor of an apparatus, cause the apparatus at least to perform any of the foregoing methods.

According to some aspects, there is provided the subject matter of the independent claims. Some further aspects are defined in the dependent claims.

### BRIEF DESCRIPTION OF THE DRAWINGS

Some example embodiments will now be described with reference to the accompanying drawings.

FIG. 1 is a diagram of an example embodiment of wireless networking between a network system and a user equipment (UE), according to one illustrated aspect of the disclosure;

FIG. 2 is a diagram of example components of a network system, according to one illustrated aspect of the disclosure;

FIG. 3 is a diagram of an example embodiment of signals and operations among a UE, an SMF, and a PCF, according to one illustrated aspect of the disclosure; and

FIG. 4 is a diagram of an example embodiment of components of a UE or of a network apparatus, according to one illustrated aspect of the present disclosure.

### DETAILED DESCRIPTION

In the following description, certain specific details are set forth in order to provide a thorough understanding of disclosed aspects. However, one skilled in the relevant art will recognize that aspects may be practiced without one or more of these specific details or with other methods, components, materials, etc. In other instances, well-known structures associated with transmitters, receivers, or transceivers have not been shown or described in detail to avoid unnecessarily obscuring descriptions of the aspects.

Reference throughout this specification to “one aspect” or “an aspect” means that a particular feature, structure, or characteristic described in connection with the aspect is included in at least one aspect. Thus, the appearances of the phrases “in one aspect” or “in an aspect” in various places throughout this specification are not necessarily all referring to the same aspect. Furthermore, the particular features, structures, or characteristics may be combined in any suitable manner in one or more aspects.

Embodiments described in the present disclosure may be implemented in wireless networking apparatuses, such as, without limitation, apparatuses utilizing Worldwide Interoperability for Microwave Access (WiMAX), Global System for Mobile communications (GSM, 2G), GSM EDGE radio access Network (GERAN), General Packet Radio Service (GRPS), Universal Mobile Telecommunication System (UMTS, 3G) based on basic wideband-code division multiple access (W-CDMA), high-speed packet access (HSPA), Long Term Evolution (LTE), LTE-Advanced, enhanced LTE (eLTE), 5G New Radio (5G NR), 5G Advance, 6G (and beyond) and 802.11ax (Wi-Fi 6), among other wireless networking systems. The term ‘eLTE’ here denotes the LTE evolution that connects to a 5G core. LTE is also known as evolved UMTS terrestrial radio access (EUTRA) or as evolved UMTS terrestrial radio access network (EUTRAN).

The present disclosure may use the term “serving network device” to refer to a network node or network device (or a portion thereof) that services a UE. As used herein, the terms “transmit to,” “receive from,” and “cooperate with,” (and their variations) include communications that may or may not involve communications through one or more intermediate devices or nodes. The term “acquire” (and its variations) includes acquiring in the first instance or reacquiring after the first instance. The term “connection” may mean a physical connection or a logical connection.

The present disclosure uses 5G NR as an example of a wireless network and may use smartphones and/or extended reality headsets as an example of UEs. It is intended and shall be understood that such examples are merely illustrative, and the present disclosure is applicable to other wireless networks and user equipment.

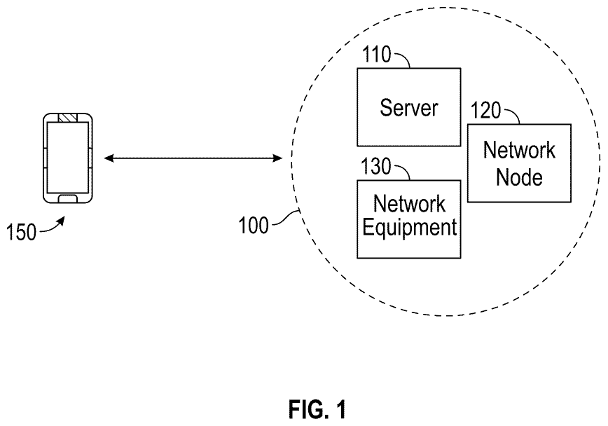

FIG. 1 is a diagram depicting an example of wireless networking between a network system 100 and a user equipment (UE) 150. The network system 100 may include one or more network nodes 120, one or more servers 110, and/or one or more network equipment 130 (e.g., test equipment). The network nodes 120 will be described in more detail below. As used herein, the term “network apparatus” may refer to any component of the network system 100, such as the server 110, the network node 120, the network equipment 130, any component(s) of the foregoing, and/or any other component(s) of the network system 100. Examples of network apparatuses include, without limitation, apparatuses implementing aspects of 5G NR, among others. The present disclosure describes embodiments related to 5G NR and embodiments that involve aspects defined by 3rd Generation Partnership Project (3GPP). However, it is contemplated that embodiments relating to other wireless networking technologies are encompassed within the scope of the present disclosure.

The following description provides further details of examples of network nodes. In a 5G NR network, a gNodeB (also known as gNB) may include, e.g., a node that provides new radio (NR) user plane and control plane protocol terminations towards the UE and that is connected via a NG interface to the 5G core (5GC), e.g., according to 3GPP TS 38.300 V16.6.0 (2021-06) section 3.2, which is hereby incorporated by reference herein.

A gNB supports various protocol layers, e.g., Layer 1 (L1)—physical layer, Layer 2 (L2), and Layer 3 (L3).

The layer 2 (L2) of NR is split into the following sublayers: Medium Access Control (MAC), Radio Link Control (RLC), Packet Data Convergence Protocol (PDCP) and Service Data Adaptation Protocol (SDAP), where, e.g.:
The physical layer offers to the MAC sublayer transport channels;
The MAC sublayer offers to the RLC sublayer logical channels;
The RLC sublayer offers to the PDCP sublayer RLC channels;
The PDCP sublayer offers to the SDAP sublayer radio bearers;
The SDAP sublayer offers to 5GC quality of service (QOS) flows;
Control channels include broadcast control channel (BCCH) and physical control channel (PCCH).

Layer 3 (L3) includes, e.g., radio resource control (RRC), e.g., according to 3GPP TS 38.300 V16.6.0 (2021-06) section 6, which is hereby incorporated by reference herein.

A gNB central unit (gNB-CU) includes, e.g., a logical node hosting, e.g., radio resource control (RRC), service data adaptation protocol (SDAP), and packet data convergence protocol (PDCP) protocols of the gNB or RRC and PDCP protocols of the en-gNB, that controls the operation of one or more gNB distributed units (gNB-DUs). The gNB-CU terminates the F1 interface connected with the gNB-DU. A gNB-CU may also be referred to herein as a CU, a central unit, a centralized unit, or a control unit.

A gNB Distributed Unit (gNB-DU) includes, e.g., a logical node hosting, e.g., radio link control (RLC), media access control (MAC), and physical (PHY) layers of the gNB or en-gNB, and its operation is partly controlled by the gNB-CU. One gNB-DU supports one or multiple cells. One cell is supported by only one gNB-DU. The gNB-DU terminates the F1 interface connected with the gNB-CU. A gNB-DU may also be referred to herein as DU or a distributed unit.

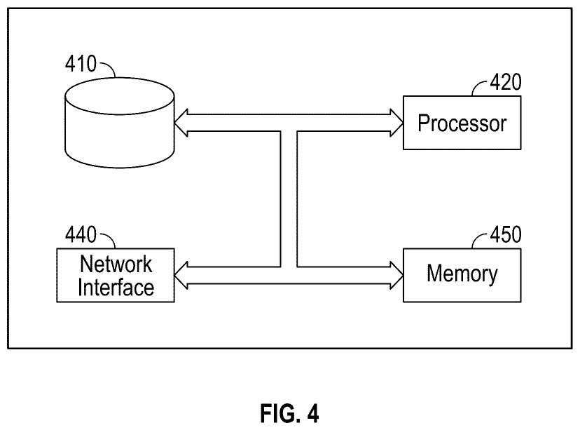

As used herein, the term “network node” may refer to any of a gNB, a gNB-CU, or a gNB-DU, or any combination of them. A RAN (radio access network) node or network node such as, e.g., a gNB, gNB-CU, or gNB-DU, or parts thereof, may be implemented using, e.g., an apparatus with at least one processor and/or at least one memory with processor-readable instructions (“program”) configured to support and/or provision and/or process CU and/or DU related functionality and/or features, and/or at least one protocol (sub-) layer of a RAN (radio access network), e.g., layer 2 and/or layer 3. Different functional splits between the central and distributed unit are possible. An example of such an apparatus and components will be described in connection with FIG. 4 below.

The gNB-CU and gNB-DU parts may, e.g., be co-located or physically separated. The gNB-DU may even be split further, e.g., into two parts, e.g., one including processing equipment and one including an antenna. A central unit (CU) may also be called baseband unit/radio equipment controller/cloud-RAN/virtual-RAN (BBU/REC/C-RAN/V-RAN), open-RAN (O-RAN), or part thereof. A distributed unit (DU) may also be called remote radio head/remote radio unit/radio equipment/radio unit (RRH/RRU/RE/RU), or part thereof. Hereinafter, in various example embodiments of the present disclosure, a network node, which supports at least one of central unit functionality or a layer 3 protocol of a radio access network, may be, e.g., a gNB-CU. Similarly, a network node, which supports at least one of distributed unit functionality or a layer 2 protocol of the radio access network, may be, e.g., a gNB-DU.

A gNB-CU may support one or multiple gNB-DUs. A gNB-DU may support one or multiple cells and, thus, could support a serving cell for a user equipment (UE) or support a candidate cell for handover, dual connectivity, and/or carrier aggregation, among other procedures.

The user equipment (UE) 150 may be or include a wireless or mobile device, an apparatus with a radio interface to interact with a RAN (radio access network), a smartphone, an in-vehicle apparatus, an IoT device, or a M2M device, among other types of user equipment. Such UE 150 may include: at least one processor; and at least one memory including program code; where the at least one memory and the computer program code are configured to, with the at least one processor, cause the apparatus at least to perform certain operations, such as, e.g., RRC connection to the RAN. An example of components of a UE will be described in connection with FIG. 4. In embodiments, the UE 150 may be configured to generate a message (e.g., including a cell ID) to be transmitted via radio towards a RAN (e.g., to reach and communicate with a serving cell). In embodiments, the UE 150 may generate and transmit and receive RRC messages containing one or more RRC PDUs (packet data units). Persons skilled in the art will understand RRC protocol as well as other procedures a UE may perform.

With continuing reference to FIG. 1, in the example of a 5G NR network, the network system 100 provides one or more cells, which define a coverage area of the network system 100. As described above, the network system 100 may include a gNB of a 5G NR network or may include any other apparatus configured to control radio communication and manage radio resources within a cell. As used herein, the term “resource” may refer to radio resources, such as a resource block (RB), a physical resource block (PRB), a radio frame, a subframe, a time slot, a sub-band, a frequency region, a sub-carrier, a beam, etc. In embodiments, the network node 120 may be called a base station.

FIG. 1 provides an example and is merely illustrative of a network system 100 and a UE 150. Persons skilled in the art will understand that the network system 100 includes components not illustrated in FIG. 1 and will understand that other user equipment may be in communication with the network system 100.

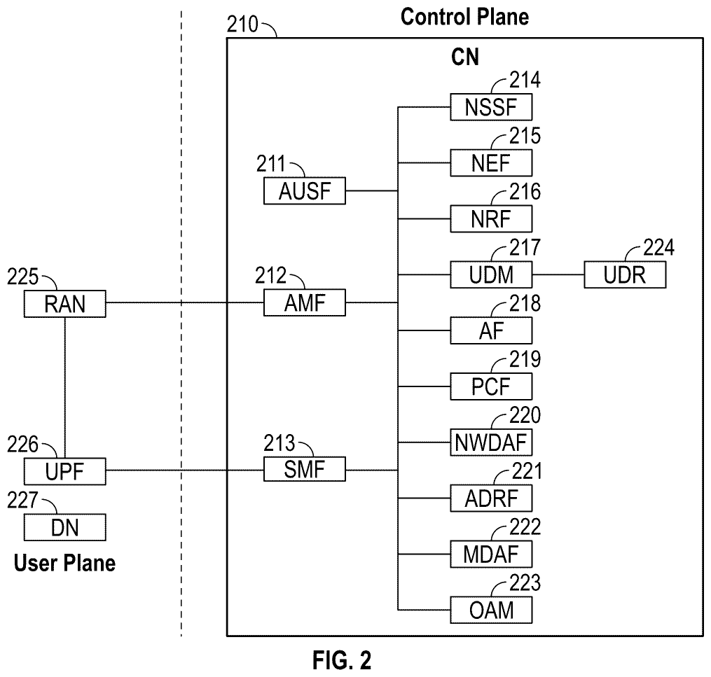

FIG. 2 is a block diagram of example components of the network system 100 of FIG. 1. A 5G NR network may be described as an example of the network system 100, and it is intended that aspects of the following description shall be applicable to other types of network systems, as well. The network system may operate in accordance with the signals and connections shown in FIG. 1 such that the UE 150 is in communication with the network system 100 through the radio access network 225. Additionally, the network system may be divided into user plane components and functions and control plane components and functions, as shown and described herein. Unless indicated otherwise, the terms “component”, “function”, and “service” may be used interchangeably herein, and they may refer to and be implemented by instructions executed by one or more processors.

Example functions of the components are described below. The example functions are merely illustrative, and it shall be understood that additional operations and functions may be performed by the components described herein. Additionally, the connections between components may be virtual connections over service-based interfaces such that any component may communicate with any other component. In this manner, any component may act as a service “producer,” for any other component that is a service “consumer,” to provide services for network functions.

For example, a core network 210 is described in the control plane of the network system. The core network 210 may include an authentication server function (AUSF) 211, an access and mobility function (AMF) 212, and a session management function (SMF) 213. The core network 210 may also include a network slice selection function (NSSF) 214, a network exposure function (NEF) 215, a network repository function (NRF) 216, and a unified data management function (UDM) 217, which may include a uniform data repository (UDR) 224.

Additional components and functions of the core network 210 may include an application function 218, policy control function (PCF) 219, network data analytics function (NWDAF) 220, analytics data repository function (ADRF) 221, management data analytics function (MDAF) 222, and operations and management function (OAM) 223.

The user plane includes the UE 150, a radio access network (RAN) 225, a user plane function (UPF) 226, and a data network (DN) 227. The RAN 225 may include one or more components described in connection with FIG. 1, such as one or more network nodes. However, the RAN 225 may not be limited to such components. The UPF 226 provides connection for data being transmitted over the RAN 225. The DN 226 identifies services from service providers, Internet access, and third party services, for example.

The AMF 212 processes connection and mobility tasks. The AUSF 211 receives authentication requests from the AMF 212 and interacts with UDM 217 to authenticate and validate network responses for determination of successful authentication. The SMF 213 conducts packet data unit (PDU) session management, as well as manages session context with the UPF 226.

The NSSF 214 may select a network slicing instance (NSI) and determine the allowed network slice selection assistance information (NSSAI). This selection and determination is utilized to set the AMF 212 to provide service to the UE 150. The NEF 215 secures access to network services for third parties to create specialized network services. The NRF 216 acts as a repository to store network functions to allow the functions to register with and discover each other.

The UDM 217 generates authentication vectors for use by the AUSF 211 and ADM 212 and provides user identification handling. The UDM 217 may be connected to the UDR 224 which stores data associated with authentication, applications, or the like. The AF 218 provides application services to a user (e.g., streaming services, etc.). The PCF 219 provides policy control functionality. For example, the PCF 219 may assist in network slicing and mobility management, as well as provide quality of service (QOS) and charging functionality.

The NWDAF 220 collects data (e.g., from the UE 150 and the network system) to perform network analytics and provide insight to functions that utilize the analytics in the providing of services. The ADRF 221 allows the storage, retrieval, and removal of data and analytics by consumers. The MDAF 222 provides additional data analytics services for network functions. The OAM 223 provides provisioning and management processing functions to manage elements in or connected to the network (e.g., UE 150, network nodes, etc.).

FIG. 2 is merely an example of components of a network system, and variations are contemplated to be within the scope of the present disclosure. In embodiments, the network system may include other components not illustrated in FIG. 2. In embodiments, the network system may not include every component illustrated in FIG. 2. In embodiments, the components and connections may be implemented with different connections than those illustrated in FIG. 2. Such and other embodiments are contemplated to be within the scope of the present disclosure.

Although further detail will be provided below, as mentioned above, in order for a UE to exchange protocol data units (PDUs) with a data network via a 5G system, the UE initiates the PDU session establishment procedure in accordance with, for example, section 4.3.2.2 of 3GPP TS 23.502.

In various embodiments, the UE initiates the PDU session establishment procedure by sending a PDU session establishment request message (e.g., per section 8.3.1 of 3GPP TS 24.501) to an SMF. An SMF receiving the PDU session establishment request message either accepts or rejects the request. A UE initiating the PDU session establishment procedure determines the attributes of the PDU session that the UE is requesting to establish. In various embodiments, the attributes of the PDU session may be shown in 3GPP TS 23.501, understood by persons of skill in the art.

Briefly, a UE may utilize a UE route selection policy (URSP) to determine PDU session attributes. For example, the UE evaluates the received URSP rules in order to select a specific route (e.g., PDU session attributes) that is suitable for certain traffic for an application.

In the URSP rules, set forth, for example, in 3GPP TS 24.526, the traffic may be determined by the traffic descriptor (TD), and the route is determined by the route selection descriptor (RSD). One RSD may contain multiple parameters, and a PDU session type may include the type of PDU session (e.g., IPv4, IPv6, IPv4v6, or Ethernet). Persons of skill in the art will appreciate the PDU session types that may be specified by the RSD.

If the UE follows a selected RSD and attempts establishing a PDU session fails because the requested PDU session type could not be recognized or is not allowed, the network may respond with a 5GSM cause value #28 “unknown PDU session type” message. For example, the data name network (DNN) for which the PDU session is requested does not support the type of PDU session requested by the UE In this example case, the UE may continue to retry establishing a PDU session with the DNN multiple times, resulting in multiple failure messages.

Although further detail is provided below, briefly, in various embodiments, a UE that receives a failure message from the network (e.g., network apparatus) may attempt to establish the PDU session with the same PDU session type for another DNN that may support the PDU session type. In various embodiments, a UE that receives a failure message from the network may remember the types of PDU session types that resulted in a failure for a particular DNN, and may ignore using any RSD that includes the same PDU session type that resulted in a failure. In various embodiments, the UE may ignore any PDU session type/DNN combination for which it received a 5GSM cause value #28 “unknown PDU session type” message during the URSP rule evaluation process.

As used herein, a communication with a radio access network (RAN) may refer to and mean a communication with a portion of a RAN, such as with a network node (e.g., a DU and/or a CU), or another portion of a RAN. As used herein, a communication with a core network may refer to and mean a communication with one or more services/applications of the core network, such as AMF or another service of a core network.

As used herein, in various embodiments, the terms “first” and “second”, or the like, may refer to a first or second instance of a message being transmitted/received by a component (e.g., UE, apparatus, etc.), or a first or second component in a sequence of described components. In various embodiments, the terms “first” and “second” do not imply any order. As such, the terms are used in a non-limiting manner, and can refer to any message, operation, device, component, or the like.

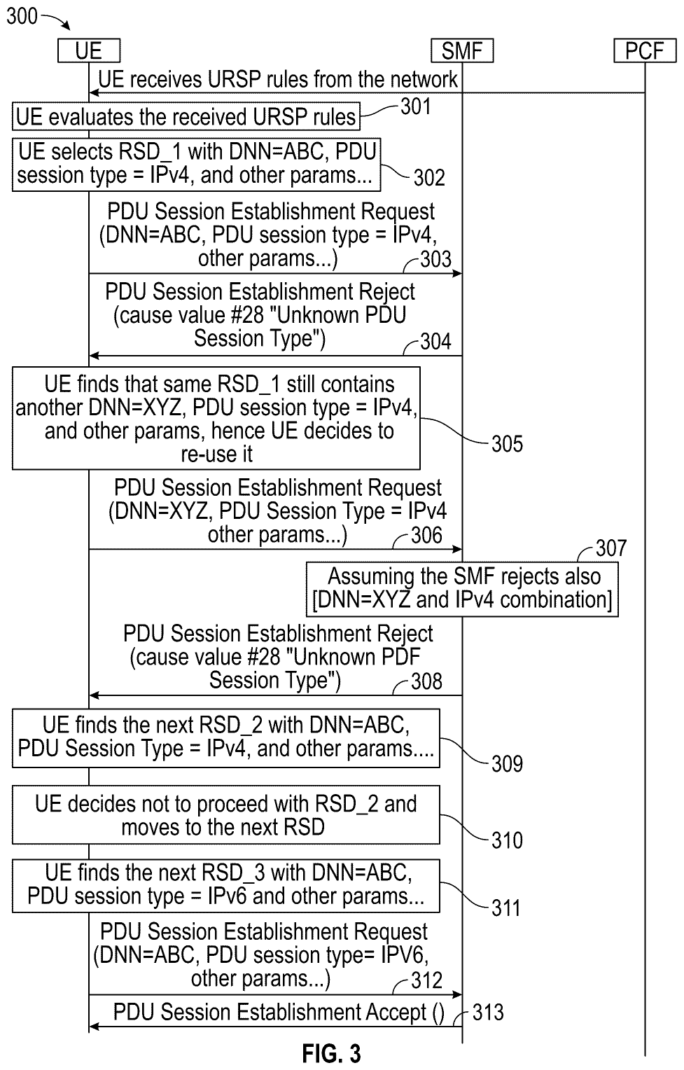

In accordance with the brief description, FIG. 3 is a diagram of an example embodiment of signals and operations 300 among a UE, an SMF, and a PCF, according to one illustrated aspect of the disclosure. The following paragraphs will describe various signals and operations. It will be understood that a described signal may have associated operations and a described operation may have associated signals.

As shown in FIG. 3, the UE may include UE 150 described in FIG. 1, while the SMF may include the SMF 213, and the PCF may include the PCF 219 described in FIG. 2.

Prior to operation 301, the PCF transmits a message that includes the URSP rules and the UE receives the message including the URSP rules. Upon receipt of the URSP rules, at operation 301, the UE evaluates the URSP rules with relation to selecting an RSD and DNN included in the URSP rules. In various embodiments, the UE may select a first RSD and a first DNN to attempt establish a PDU session for communication with the network.

At operation 302, for example, the UE may select a first RSD (e.g., RSD_1) with a first DNN (e.g., DNN=ABC), that includes a first PDU session type (e.g., IPv4) as well as one or more other parameters/attributes (e.g., attributes-NSSAI, session and service continuity (SSC) mode). Persons of skill in the art will appreciate that any type of RSD, DNN and PDU session may be selected in accordance with operation 302.

In various embodiments, PDU session types, such as the first PDU session type may includes any one of the following: IPv4, IPv6, IPv4v6, Unstructured or Ethernet PDU session types. In one or more embodiments, the attributes may include any one or more of the following: the DNN, an access point name (APN), or a single network slice selection assistance information (S-NSSAI). In various embodiments, an RSD may include a packet data network (PDN) session.

Accordingly, at operation 303, the UE transmits a PDU session establishment request message to the SMF and the SMF receives the PDU session establishment request message. In various embodiments, the PDU session establishment request message includes the selection of the UE for the PDU session (e.g., DNN=ABC, PDU session type=IPv4, other parameters, etc.).

Upon receipt of the PDU session establishment request message, if the DNN requested does not support the PDU session type requested, for example, at operation 304, the SMF transmits a PDU session establishment reject (cause value #28 “unknown PDU session type”) message to the UE, and the UE receives the PDU session establishment reject (cause value #28 “unknown PDU session type”) message. In various embodiments, a session rejection message such as a PDU session establishment reject message may be an evolved packet system session management (ESM) message that includes a cause value #28 of unknown PDN. In various embodiments, a rejected combination of the first PDU session type and the first one or more attributes may be stored (e.g., in a memory) such that a session establishment request is not requested again for that rejected combination.

Upon receipt of the PDU session establishment reject (cause value #28 “unknown PDU session type”) message from the SMF, at operation 305, the UE may determine that the first RSD includes another/second DNN (e.g., DNN=XYZ), the first PDU session type and the other parameters for which the UE seeks to establish communication with the network. Accordingly, the UE may decide to reuse the first RSD combined with the second DNN.

Accordingly, in various embodiments, at operation 306, the UE transmits a second PDU session establishment request message to the SMF and the SMF receives the second PDU session establishment request message. The second PDU session establishment request message includes the selection of the UE for the PDU session (e.g., DNN=XYZ, PDU session type=IPv4, other parameters, etc.).

If the 5GSM cause value in the PDU session establishment reject message at operation 304 is #28 “unknown PDU session type” and the PDU session establishment request message sent at operation 305 contained a PDU session type IE indicating a PDU session type, the UE 300 shall ignore the Back-off timer value IE and Re-attempt indicator IE provided by the network, if any. The UE 300 may send another PDU session establishment request message 306 to establish a new PDU session with another DNN (e.g., using another DNN, if any, in the same route selection descriptor) or another PDU session type (e.g., using another PDU session type in another route selection descriptor, if any). The behavior of the UE for 5GSM cause value #28 also applies if the PDU session is a multi-access PDU Session.

Similar operations can be applied to EPS. If the ESM cause value in the PDN connectivity reject message at operation 304 is #28 “unknown PDN type” and the PDN CONNECTIVITY REQUEST message sent at operation 305 contained a PDN type IE indicating a PDN connection type, the UE shall ignore the Back-off timer value IE and Re-attempt indicator IE provided by the network, if any. The UE 300 may send another PDN connectivity request message 306 with the PDN type IE indicating another PDN connection type or with the Access point name IE indicating another access point name.

If the second DNN supports the PDU session requested, then the PDU session is established. For purposes of example, at operation 307, it is presented that the SMF rejects the new combination set forth in the second PDU session establishment request message.

Accordingly, at operation 308, the SMF transmits a PDU session establishment reject (cause value #28 “unknown PDU session type”) message to the UE, and the UE receives the PDU session establishment reject (cause value #28 “unknown PDU session type”) message.

Upon receipt of the PDU session establishment reject (cause value #28 “unknown PDU session type”) message at operation 308, the UE determines, at operation 309, the next RSD (e.g., RSD_2) with the first DNN, first PDU session type, and other parameters. At operation 310, in various embodiments, the UE decides to not establish a PDU session with the second RSD, and determines a subsequent RSD to establish communication. Accordingly, at operation 311, the UE determines the subsequent RSD (e.g., RSD_3) with the first DNN (DNN=ABC), a second PDU session type (e.g., IPv6), and other parameters for which to establish a PDU session.

In various embodiments, as the UE evaluates an RSD, if the RSD includes a PDU session type and one or more DNNs and the network has rejected the request to establish a PDU session with 5GSM cause value #28 “unknown PDU session type” or a PDN connection with ESM cause value #28 “unknown PDN connection type” for all possible [PDU session type, DNN] combination(s) contained in the selected route selection descriptor, or if the RSD includes no DNN and the network has rejected the request to establish a PDU session with 5GSM cause value #28 or a PDN connection with ESM cause value #28 “unknown PDN connection type” for the [PDU session type, no DNN] combination, the UE does not use the RSD for establishment of a PDU session or a PDN connection and evaluates another RSD or other information in the UE.

Accordingly, at operation 312, the UE transmits a subsequent PDU session establishment request message to the SMF and the SMF receives the subsequent PDU session establishment request message. The subsequent PDU session establishment request message includes the selection of the UE for the PDU session (e.g., DNN=ABC, PDU session type=IPv6, other parameters, etc.). In various embodiments, the UE may transmit subsequent PDU session establishment request messages to another SMF (e.g., a second SMF). In various embodiments, the UE may transmit subsequent PDU session establishment request messages to the same SMF the UE transmitted the first PDU session establishment request message.

Upon acceptance of the PDU session, the SMF transmits a PDU session establishment accept message to the UE and the UE receives the PDU session establishment accept message. In various embodiments, the UE may remember and ignore (e.g., skip) any next RSD that contains a same PDU session type that was rejected with the 5GSM cause value #28 “unknown PDU session type” for the same DNN. For example, the UE may skip any PDU session type/DNN combination for which the UE has received a 5GSM cause value #28 “unknown PDU session type” message in the URSP rule evaluation process. In various embodiments, prior to transmitting a PDU session establishment request, stored combinations of the PDU session type/one or more attributes (e.g., DNN) may be reviewed/consulted, so as to not use (e.g., skip) those combinations for PDU session establishment.

The operations of FIG. 3 are merely illustrative, and variations are contemplated to be within the scope of the present disclosure. In embodiments, the operations may include other operations not illustrated in FIG. 3. In embodiments, the operations may not include every operation illustrated in FIG. 3. In embodiments, the operations may be implemented in a different order than that illustrated in FIG. 3. Such and other embodiments are contemplated to be within the scope of the present disclosure. Persons of skill in the art will appreciate that, although various example components are described as perform various functions, other components may perform those functions described in the diagram 300.

The following describes operations from the perspective of UE. From such a perspective, a method may include transmitting, by a user equipment (UE), a first message to a first apparatus, the first message including a request to establish communication based on a first communication session type and a first set of one or more session attributes associated with the first message. The UE receives a second message from the first apparatus, the second message including an indication that the request to establish communication using the first communication session type is rejected, and after the receiving the second message, removes from use, a retransmission of the first communication session type and the first set of one or more session attributes for establishing communication, and transmits a third message to the first apparatus or a second apparatus, the third message including a request for communication based on a second communication session type and a second set of one or more session attributes, associated with the third message, wherein a first combination including the first communication session type and the first set of one or more session attributes, is not identical to a second combination including the second communication session type and the second set of one or more session attributes.

Referring now to FIG. 4, there is shown a block diagram of example components of a UE or a network apparatus (e.g., of a RAN or a core network). The apparatus includes an electronic storage 410, a processor 420, a network interface 440, and a memory 450. The various components may be communicatively coupled with each other. The processor 420 may be and may include any type of processor, such as a single-core central processing unit (CPU), a multi-core CPU, a microprocessor, a digital signal processor (DSP), a System-on-Chip (SoC), or any other type of processor. The memory 450 may be a volatile type of memory, e.g., RAM, or a non-volatile type of memory, e.g., NAND flash memory. The memory 450 includes processor-readable instructions that are executable by the processor 420 to cause the apparatus to perform various operations, including those mentioned herein, such as the operations of FIG. 3.

The electronic storage 410 may be and include any type of electronic storage used for storing data, such as hard disk drive, solid state drive, optical disc, and/or other non-transitory computer-readable mediums, among other types of electronic storage. The electronic storage 410 stores processor-readable instructions for causing or configured for causing the apparatus to perform its operations and also stores data associated with such operations, such as storing data relating to 5G NR standards, among other data. The network interface 440 may implement wireless networking technologies such as 5G NR and/or other wireless networking technologies.

The components shown in FIG. 4 are merely examples, and persons skilled in the art will understand that an apparatus includes other components not illustrated and may include multiples of any of the illustrated components. Such and other embodiments are contemplated to be within the scope of the present disclosure. For example, a transmitter and a receiver may be included as components for transmitting and receiving signals.

Further embodiments of the present disclosure include the following examples.

Example 1.1. A user equipment (UE), including:
means for transmitting, by the UE, a first message to a first apparatus, the first message including a request to establish communication based on a first communication session type and a first set of one or more session attributes associated with the first message;
means for receiving, by the UE, a second message from the first apparatus, the second message including an indication that the request to establish communication using the first communication session type is rejected;
means for, after the receiving the second message, removing from use, a retransmission of the first communication session type and the first set of one or more session attributes for establishing communication; and
means for transmitting, by the UE, a third message to the first apparatus or a second apparatus, the third message including a request for communication based on a second communication session type and a second set of one or more session attributes, associated with the third message, wherein a first combination including the first communication session type and the first set of one or more session attributes, is not identical to a second combination including the second communication session type and the second set of one or more session attributes.

Example 1.2. The UE of example 1.1, wherein the request to establish communication based on the first communication session type includes a request to establish a protocol data unit (PDU) communication session type or a packet data network (PDN) communication session type.

Example 1.3. The UE of example 1.2, wherein the PDU communication session type includes one or more of the following: an IPv4 communication session type, an IPv6 communication session type, an IPv4v6 communication session type, an Unstructured communication session type or an Ethernet communication session type.

Example 1.4. The UE of example 1.2, wherein the PDN communication session type includes one or more of the following: an IPv4 communication session type, an IPv6 communication session type, an IPv4v6 communication session type, non-Internet protocol (IP) communication session type or an Ethernet communication session type.

Example 1.5. The UE of example 1.1, wherein the first set of one or more session attributes comprises a first data network name (DNN) or a first access point name (APN).

Example 1.6. The UE of example 1.5, wherein the second set of one or more session attributes comprises a second DNN or a second APN.

Example 1.7. The UE of example 1.1 wherein the first set of one or more session attributes comprises a first single network slice selection assistance information (S-NSSAI).

Example 1.8. The UE of example 1.7, wherein the second set of one or more session attributes comprises a second S-NSSAI.

Example 1.9 The UE of example 1.1, wherein the first communication session type and the first set of one or more session attributes are included in a first route selection descriptor (RSD).

Example 1.10. The UE of example 1.1, wherein the second communication session type and the second set of one or more session attributes are included in a second RSD.

Example 1.11. The UE of example 1.1, wherein the first communication session type and the second communication session type are identical or the first set of one or more session attributes and the second set of one or more session attributes are identical.

Example 1.12. The UE of example 1.1, wherein the second message is a 5G system session management (5GSM) message that includes an indication of an unknown PDU session type.

Example 1.13. The UE of example 1.12, wherein the second message includes a 5GSM cause value #28 unknown PDU session type.

Example 1.14. The UE of example 1.1, wherein the second message is an evolved packet system session management (ESM) message that includes an indication of an unknown packet data network (PDN) session.

Example 1.15. The UE of example 1.14, wherein the second message is an ESM cause value #28 unknown PDN session message.

Example 1.16. The UE of example 1.1, wherein the removing from use includes storing, by the UE, the first combination as a combination to not be used.

Example 1.17. The UE of example 1.16, wherein prior to transmitting the third message, consulting, by the UE, the combinations to not be used.

Example 2.1. A user equipment (UE), including:
at least one processor; and
at least one memory storing instructions which, when executed by the at least one processor, cause the apparatus at least to:
transmit a first message to a first apparatus, the first message including a request to establish communication based on a first communication session type and a first set of one or more session attributes associated with the first message;
receive a second message from the first apparatus, the second message including an indication that the request to establish communication using the first communication session type is rejected;
after the receiving the second message, remove from use, a retransmission of the first communication session type and the first set of one or more session attributes for establishing communication; and
transmit a third message to the first apparatus or a second apparatus, the third message including a request for communication based on a second communication session type and a second set of one or more session attributes, associated with the third message, wherein a first combination including the first communication session type and the first set of one or more session attributes, is not identical to a second combination including the second communication session type and the second set of one or more session attributes.

The embodiments and aspects disclosed herein are examples of the present disclosure and may be embodied in various forms. For instance, although certain embodiments herein are described as separate embodiments, each of the embodiments herein may be combined with one or more of the other embodiments herein. Specific structural and functional details disclosed herein are not to be interpreted as limiting, but as a basis for the claims and as a representative basis for teaching one skilled in the art to variously employ the present disclosure in virtually any appropriately detailed structure. Like reference numerals may refer to similar or identical elements throughout the description of the figures.

For example, as described above, in various embodiments, in a PDU session establishment operation with URSP rules, a UE for which the PDU session establishment is rejected with 5GSM cause value #28 “unknown PDU session type” for a PDU session type and a certain DNN and the RSD used for the request contains other DNNs, the UE may retry the PDU session establishment using the same PDU session type but with a different DNN value, before moving evaluating another RSD.

In various embodiments, a UE may ignore/skip any next RSD that contains the same PDU session type that was rejected with 5GSM cause value #28 “unknown PDU session type” for the same DNN. For example, the UE skips any PDU session type/DNN combination for which the UE has received a 5GSM cause value #28 “unknown PDU session type” message in the URSP rule evaluation process.

In various embodiments, the UE may save the time and signaling overhead of retrying another PDU session establishment with the same DNN and PDU session type combination that would fail again with the same 5GSM cause value #28 “unknown PDU session type”.

Although the operations and signals above are described within the context of a 5G wireless system, the operations and signals may apply to any type of communication network. In various embodiments, although #28 implies that the specific combination of DNN and PDU session type is rejected, a UE can attempt a request with a different DNN and single-network slice selection assistance information (S-NSSAI) slice combination for the same PDU session type.

The phrases “in an aspect,” “in aspects,” “in various aspects,” “in some aspects,” or “in other aspects” may each refer to one or more of the same or different aspects in accordance with this present disclosure. The phrase “a plurality of” may refer to two or more.

In various embodiments, the terms “first message” and “second message”, as well as any subsequent messages may refer to any messages that are transmitted or received in an order and are not necessarily limited to any particular message.

The phrases “in an embodiment,” “in embodiments,” “in various embodiments,” “in some embodiments,” or “in other embodiments” may each refer to one or more of the same or different embodiments in accordance with the present disclosure. A phrase in the form “A or B” means “(A), (B), or (A and B).” A phrase in the form “at least one of A, B, or C” means “(A); (B); (C); (A and B); (A and C); (B and C); or (A, B, and C).”

Any of the herein described methods, programs, algorithms or codes may be converted to, or expressed in, a programming language or computer program. The terms “programming language” and “computer program,” as used herein, each include any language used to specify instructions to a computer, and include (but is not limited to) the following languages and their derivatives: Assembler, Basic, Batch files, BCPL, C, C+, C++, Delphi, Fortran, Java, JavaScript, machine code, operating system command languages, Pascal, Perl, PL1, Python, scripting languages, Visual Basic, metalanguages which themselves specify programs, and all first, second, third, fourth, fifth, or further generation computer languages. Also included are database and other data schemas, and any other meta-languages. No distinction is made between languages which are interpreted, compiled, or use both compiled and interpreted approaches. No distinction is made between compiled and source versions of a program. Thus, reference to a program, where the programming language could exist in more than one state (such as source, compiled, object, or linked) is a reference to any and all such states. Reference to a program may encompass the actual instructions and/or the intent of those instructions.

While aspects of the present disclosure have been shown in the drawings, it is not intended that the present disclosure be limited thereto, as it is intended that the present disclosure be as broad in scope as the art will allow and that the specification be read likewise. Therefore, the above description should not be construed as limiting, but merely as exemplifications of particular aspects. Those skilled in the art will envision other modifications within the scope and spirit of the claims appended hereto.

What is claimed is:

1. An apparatus, comprising:
at least one processor; and
at least one memory storing instructions which, when executed by the at least one processor, cause the apparatus at least to perform:
transmitting a first message to a first apparatus, the first message including a request to establish communication based on a first communication session type and a first set of one or more session attributes associated with the first message;
receiving a second message from the first apparatus, the second message including an indication that the request to establish communication using the first communication session type is rejected;
after the receiving the second message, removing from use, a retransmission of the first communication session type and the first set of one or more session attributes for establishing communication; and
transmitting a third message to the first apparatus or a second apparatus, the third message including a request for communication based on a second communication session type and a second set of one or more session attributes, associated with the third message, wherein a first combination including the first communication session type and the first set of one or more session attributes, is not identical to a second combination including the second communication session type and the second set of one or more session attributes, and wherein the first communication session type and the second communication session type are identical.

2. The apparatus according to claim 1, wherein the request to establish communication based on the first communication session type includes a request to establish a protocol data unit (PDU) communication session type or a packet data network (PDN) communication session type.

3. The apparatus according to claim 2, wherein the PDU communication session type includes one or more of the following: an IPv4 communication session type, an IPv6 communication session type, an IPv4v6 communication session type, an unstructured communication session type or an Ethernet communication session type.

4. The apparatus according to claim 2, wherein the PDN communication session type includes one or more of the following: an IPv4 communication session type, an IPv6 communication session type, an IPv4v6 communication session type, non-Internet protocol (IP) communication session type or an Ethernet communication session type.

5. The apparatus according to claim 1, wherein the first set of one or more session attributes comprises a first data network name (DNN) or a first access point name (APN).

6. The apparatus according to claim 5, wherein the second set of one or more session attributes comprises a second DNN or a second APN.

7. The apparatus according to claim 1 wherein the first set of one or more session attributes comprises a first single network slice selection assistance information (S-NSSAI).

8. The apparatus according to claim 7, wherein the second set of one or more session attributes comprises a second S-NSSAI.

9. The apparatus according to claim 1, wherein the first communication session type and the first set of one or more session attributes are included in a first route selection descriptor (RSD).

10. The apparatus according to claim 1, wherein the second communication session type and the second set of one or more session attributes are included in a second RSD.

11. The apparatus according to claim 1, wherein the second message is a 5G system session management (5GSM) message that includes an indication of an unknown PDU session type.

12. The apparatus according to claim 11, wherein the second message includes a 5GSM cause value #28 unknown PDU session type.

13. The apparatus according to claim 1, wherein the second message is an evolved packet system session management (ESM) message that includes an indication of an unknown packet data network (PDN) session.

14. The apparatus according to claim 13, wherein the second message is an ESM cause value #28 unknown PDN session message.

15. The apparatus according to claim 1, wherein the removing from use includes storing, by the UE, the first combination as a combination to not be used.

16. The apparatus according to claim 15, wherein prior to the transmitting the third message, consulting the combination to not be used.

17. The apparatus according to claim 1, wherein the apparatus comprises a user equipment (UE).

18. A method comprising:
transmitting a first message to a first apparatus, the first message including a request to establish communication based on a first communication session type and a first set of one or more session attributes associated with the first message;
receiving a second message from the first apparatus, the second message including an indication that the request to establish communication using the first communication session type is rejected;
after the receiving the second message, removing from use, a retransmission of the first communication session type and the first set of one or more session attributes for establishing communication; and
transmitting a third message to the first apparatus or a second apparatus, the third message including a request for communication based on a second communication session type and a second set of one or more session attributes, associated with the third message, wherein a first combination including the first communication session type and the first set of one or more session attributes, is not identical to a second combination including the second communication session type and the second set of one or more session attributes, and wherein the first communication session type and the second communication session type are identical.

19. The method according to claim 18, wherein the request to establish communication based on the first communication session type includes a request to establish a protocol data unit (PDU) communication session type or a packet data network (PDN) communication session type.

20. A processor-readable medium storing instructions which, when executed by at least one processor of an apparatus, cause the apparatus at least to perform:
transmitting a first message to a first apparatus, the first message including a request to establish communication based on a first communication session type and a first set of one or more session attributes associated with the first message;
receiving a second message from the first apparatus, the second message including an indication that the request to establish communication using the first communication session type is rejected;
after the receiving the second message, removing from use, a retransmission of the first communication session type and the first set of one or more session attributes for establishing communication; and
transmitting a third message to the first apparatus or a second apparatus, the third message including a request for communication based on a second communication session type and a second set of one or more session attributes, associated with the third message, wherein a first combination including the first communication session type and the first set of one or more session attributes, is not identical to a second combination including the second communication session type and the second set of one or more session attributes, and wherein the first communication session type and the second communication session type are identical.
